(19) United States
(12) Patent Application Publication
(10) Pub. No.: US 2025/0156551 A1
(43) Pub. Date: May 15, 2025

(54) TECHNIQUES FOR IMPLEMENTING TRUSTED BINARIES FOR MICROCONTROLLERS

(71) Applicant: Analog Devices, Inc., Wilmington, MA (US)

(72) Inventor: Tanmaya Mishra, Wilmington, MA (US)

(21) Appl. No.: 18/933,373

(22) Filed: Oct. 31, 2024

Related U.S. Application Data
(60) Provisional application No. 63/598,851, filed on Nov. 14, 2023.

(51) Int. Cl. G06F 21/57

(52) U.S. Cl. CPC G06F 21/575

(57) ABSTRACT

Techniques for implementing trusted binaries for microcontrollers are provided. In one aspect, a security partitioned microcontroller includes a primary processor, a co-processor, and a memory segmented into a trusted portion and a non-trusted portion. The co-processor is configured to in response to booting the security partitioned microcontroller, scan the trusted portion of the memory for a first set of instructions, and allow the primary processor to boot in response to determining that the first set of instructions is present in the trusted portion of the memory.

### CROSS-REFERENCE TO RELATED APPLICATION(S)

Any and all applications for which a foreign or domestic priority claim is identified in the Application Data Sheet as filed with the present application are hereby incorporated by reference under 37 CFR 1.57.

This application claims the benefit of priority of U.S. Provisional Application No. 63/598,851, filed Nov. 14, 2023, the entire disclosure of which is incorporated herein by reference in its entirety and for all purposes.

### BACKGROUND

### Field of the Disclosure

Embodiments of the disclosure relate to security partitioned microcontrollers, and in particular, implementing trusted binaries on such microcontrollers.

### Description of the Related Technology

Microcontrollers can be configured employ security partitioning (or memory segmentation). Security partitioning includes creating secure (also referred to as trusted) and non-secure (also referred to as non-trusted) environments or domains. One example of this type of security partitioning is TrustZone, which is implemented in certain microcontrollers, for example, Cortex-M33 and Cortex-M23 microcontrollers.

### SUMMARY OF THE DISCLOSURE

The methods and devices of the described technology each have several aspects, no single one of which is solely responsible for its desirable attributes.

In one aspect, there is provided a security partitioned microcontroller, comprising: a primary processor; a memory coupled to the primary processor, wherein the memory is segmented into a trusted portion and a non-trusted portion, the memory having stored thereon a first set of instructions in the trusted portion and a second set of instructions in the non-trusted portion; and a co-processor configured to: in response to booting the security partitioned microcontroller, scan the trusted portion of the memory for the first set of instructions, and allow the primary processor to boot in response to determining that the first set of instructions is present in the trusted portion of the memory.

In some embodiments, the first set of instructions and the second set of instructions, when executed by the primary processor, cause the primary processor to: create a trusted execution environment and execute the first set of instructions within the trusted execution environment, and create a non-trusted execution environment and execute the second set of instructions within the non-trusted execution environment.

In some embodiments, the first set of instructions are pre-flashed into the trusted portion of the memory.

In some embodiments, the microcontroller further comprises: one or more peripherals, wherein the first set of instructions comprise driver code and an application programming interface (API) for accessing the one or more peripherals.

In some embodiments, the microcontroller further comprises: a hardware-based access controller that segments the memory into the trusted portion and the non-trusted portion wherein the hardware-based access controller is configured to prevent access to the one or more peripherals from the non-trusted execution environment.

In some embodiments, the driver code, when executed by the primary processor, causes the primary processor to monitor usage of the one or more peripherals, generate usage metrics representing the usage of the one or more peripherals, and communicate the usage metrics to a provider of the microcontroller.

In some embodiments, the first set of instructions comprise a first sub-set of instructions provided by a provider of the microcontroller and a second sub-set of instructions provided by a user.

In some embodiments, the second set of instructions, when executed by the primary processor, cause the primary processor to: call functionality from the non-trusted execution environment to instruct the co-processor to load a third set of instructions into the trusted execution environment of the primary processor.

In some embodiments, the co-processor is further configured to: receive a request to load a user provided third set of instructions into the trusted execution environment, read the third set of instructions, verify a signature of the third set of instructions, determine that a hook code is present in the third set of instructions, determines an expected version of the third set of instructions matches a version of the hook code, and load the third set of instructions in a lower-privileged context in the trusted execution environment of the primary processor in response to verifying the signature and determining that the expected version matches the version of the hook code.

In some embodiments, the trusted execution environment comprises: a memory-protection unit (MPU) configured to run the first set of instructions in a higher-privileged operating mode.

In another aspect, there is provided a method of using a security partitioned microcontroller, comprising: scanning, using a co-processor, a trusted portion of a memory of the security partitioned microcontroller for a first set of instructions in response to booting the security partitioned microcontroller; and allowing, using the co-processor, a primary processor of the security partitioned microcontroller to boot in response to determining that the first set of instructions is present in the trusted portion of the memory.

In some embodiments, the method further comprises: creating, using the primary processor, a trusted execution environment and execute the first set of instructions within the trusted execution environment; and creating, using the primary processor, a non-trusted execution environment and execute a second set of instructions within the non-trusted execution environment, the second set of instructions being stored in a non-trusted portion of the memory.

In some embodiments, the first set of instructions are pre-flashed into the trusted portion of the memory.

In some embodiments, the microcontroller comprises one or more peripherals, and the first set of instructions comprise driver code and an application programming interface (API) for accessing the one or more peripherals.

In some embodiments, the method further comprises: preventing access, using a hardware-based access controller of the microcontroller that segments the memory into the trusted portion and the non-trusted portion, to the one or more peripherals from the non-trusted execution environment.

In some embodiments, the method further comprises: monitoring, using the driver code executed by the primary processor, usage of the one or more peripherals; generating usage metrics representing the usage of the one or more peripherals, and communicating the usage metrics to a provider of the microcontroller.

In some embodiments, the first set of instructions comprise a first sub-set of instructions provided by a provider of the microcontroller and a second sub-set of instructions provided by a user.

In some embodiments, the method further comprises: calling, using the primary processor executing the second set of instructions, functionality from the non-trusted execution environment to instruct the co-processor to load a third set of instructions into the trusted execution environment of the primary processor.

In some embodiments, the method further comprises: receiving, by the co-processor, a request to load a user provided third set of instructions into the trusted execution environment; reading the third set of instructions; verifying a signature of the third set of instructions; determining that a hook code is present in the third set of instructions; determining an expected version of the third set of instructions matches a version of the hook code; and loading, by the co-processor, the third set of instructions in a lower-privileged context in the trusted execution environment of the primary processor in response to verifying the signature and determining that the expected version matches the version of the hook code.

In some embodiments, the method further comprises: running, using a memory-protection unit (MPU) of the trusted execution environment, the first set of instructions in a higher-privileged operating mode.

In yet another aspect, there is provided a non-transitory computer-readable memory having stored thereon instructions that, when executed by a microcontroller, cause the microcontroller to: scan, using a co-processor of the microcontroller, a trusted portion of a memory of the microcontroller for a first set of instructions in response to booting the microcontroller; and allow, using the co-processor, a primary processor of the microcontroller to boot in response to determining that the first set of instructions is present in the trusted portion of the memory.

In some embodiments, the instructions, when executed by the microcontroller, cause the microcontroller to: create, using the primary processor, a trusted execution environment and execute the first set of instructions within the trusted execution environment; and create, using the primary processor, a non-trusted execution environment and execute a second set of instructions within the non-trusted execution environment, the second set of instructions being stored in the non-trusted portion of the memory.

In some embodiments, the first set of instructions are pre-flashed into the trusted portion of the memory.

In some embodiments, the microcontroller comprises one or more peripherals, and the first set of instructions comprise driver code and an application programming interface (API) for accessing the one or more peripherals.

In some embodiments, the instructions, when executed by the microcontroller, cause the microcontroller to: preventing access, using a hardware-based access controller of the microcontroller that segments the memory into the trusted portion and the non-trusted portion, to the one or more peripherals from the non-trusted execution environment.

In some embodiments, the instructions, when executed by the microcontroller, cause the microcontroller to: monitoring, using the driver code executed by the primary processor, usage of the one or more peripherals; generating usage metrics representing the usage of the one or more peripherals, and communicating the usage metrics to a provider of the microcontroller.

In some embodiments, the first set of instructions comprise a first sub-set of instructions provided by a provider of the microcontroller and a second sub-set of instructions provided by a user.

In some embodiments, the instructions, when executed by the microcontroller, cause the microcontroller to: calling, using the primary processor executing the second set of instructions, functionality from the non-trusted execution environment to instruct the co-processor to load a third set of instructions into the trusted execution environment of the primary processor.

In some embodiments, the instructions, when executed by the microcontroller, cause the microcontroller to: receiving, by the co-processor, a request to load a user provided third set of instructions into the trusted execution environment; reading the third set of instructions; verifying a signature of the third set of instructions; determining that a hook code is present in the third set of instructions; determining an expected version of the third set of instructions matches a version of the hook code; and loading, by the co-processor, the third set of instructions in a lower-privileged context in the trusted execution environment of the primary processor in response to verifying the signature and determining that the expected version matches the version of the hook code.

In some embodiments, the instructions, when executed by the microcontroller, cause the microcontroller to: running, using a memory-protection unit (MPU) of the trusted execution environment, the first set of instructions in a higher-privileged operating mode.

### BRIEF DESCRIPTION OF THE DRAWINGS

FIG. 1 is an example of a security partitioned microcontroller in accordance with aspects of this disclosure.

FIG. 2 is an example method of using a security partitioned microcontroller in accordance with aspects of this disclosure.

### DETAILED DESCRIPTION

The following detailed description of embodiments presents various descriptions of specific embodiments of the invention. However, the invention can be embodied in a multitude of different ways. In this description, reference is made to the drawings where like reference numerals may indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

Aspects of this disclosure relate to systems and techniques for metering application programming interface (API)/peripheral access on microcontrollers that employ security partitioning (or memory segmentation). Security partitioning includes creating secure (also referred to as trusted) and non-secure (also referred to as non-trusted) environments or domains. In some embodiments, this type of security partitioning may be implemented using memory segmentation mechanisms. One example of this type of security partitioning is TrustZone, which is implemented in certain microcontrollers, for example, Cortex-M33 and Cortex-M23 microcontrollers.

The systems and techniques disclosed herein allow a user of a security partitioned microcontroller to completely or substantially completely use both trusted and non-trusted domains of the microcontroller. The ability to use both domains, while still maintaining certain levels of insight into the user's operation of the microcontroller is a feature that is currently not available. This allows a user to rent/receive devices (including a TrustZone or other security partitioned microcontroller) from a manufacturer/provider, evaluate, and/or deploy such devices. Users may be able to employ these devices while optionally using usage-based billing based on the usage of device peripherals and off-device interactions such as cloud storage/computation. Examples of device peripherals of a security partitioned microcontroller that can be accessed by a user include: a digital signal processor (DSP) which can be configured to run specialized algorithms (e.g., proprietary algorithms) and/or a machine learning (ML) accelerator configured to run specialized ML models (e.g., proprietary ML models). Aspects of this disclosure also provides the ability for the user to opt-out and pay outright for the device when they wish to do so, or continue to use the device under a rental (e.g., usage based) agreement.

Memory segmentation mechanisms such as ARM TrustZone support the ability to have a “trusted execution environment” (TEE) on application and microcontroller class processing environments. Such environments have “trusted” and “untrusted” code separated by a strict hardware-based access controller (e.g., a hardware-based access control mechanism) that is included in the processor as well the System-on-Chip (SoC) buses and peripherals. Trusted code has unfettered access to the entire memory structure of the SoC and can be considered to be supervisory code. Untrusted code has lesser privileges and access rights than trusted code.

In the realm of microcontroller-class SoCs, typically a single vendor or manufacturer either creates both trusted and untrusted code, or a multi-vendor approach can be applied where a first vendor (which may be referred to as Vendor A, a provider, or a manufacturer) creates the trusted code binary, burns the trusted code into the microcontroller and then passes the device on to a second vendor (which may be referred to as Vendor B or a user) who cannot change the code provided by the first vendor but have full control over untrusted code. The second technique is rarely used, at least partially due to the lack of control by the second vendor to make changes to the code of the device, especially on the trusted side.

Aspects of this disclosure provide a modification to the multi-party approach to achieve the ability for a provider of a memory segmented device to instrument/augment code by a user such that the provider can include binaries for both trusted and untrusted memory sections, while maintaining the provider's ability execute code run alongside the user's code in the trusted environment. This can ensure that the provider has device use insight for monitoring and metering usage of the device and its peripherals. This type of monitoring can be used, for example, to provide use-based service agreements and metering capabilities. As described herein, this arrangement can be accomplished through a set of techniques, including compiler-based instrumentation, binary signing, and a trusted security co-processor that detects binary signatures and allows processor bootup.

Aspects of this disclosure provide a technique to insert both the provides code into security partitioned devices (e.g., ARM TrustZone or similar memory segmentation mechanisms for trusted execution environments) along with a user provided binary intended to be used as a trusted component.

The systems and techniques disclosed herein can be implemented using platform level software-hardware integration. Using systems that employ this type of integration enables the ability to begin providing services to users without requiring the users to purchase the hardware. For example, users may be hesitant to purchase hardware or their operational costs may prevent them from doing so at the moment. By providing techniques for controlling hardware as well as software development for digital platforms, users can be provided the opportunity to “rent” hardware as an alternative to purchasing the hardware. The ability to rent hardware can be achieved through: a) metering data ingress/egress from the rented device, with API calls to the provider's cloud services, etc., and b) providing the ability to monitor the users of the rented device to ensure they do not violate metering agreements/contracts and provide use-based billing to such users.

A unique problem can arise in these types of system, where both the provider's code as well user code is supposed to mutually co-exist, is that of who to trust. To protect the provider's code, it is desirable to have the ability to insert immutable code into the rented device, while also providing the device with the flexibility to execute arbitrary user software/firmware as would be expected from a device the user may have bought. Therefore, it is desirable to provide techniques that allow the provider's code to synergize with the user's code. This can be especially difficult to achieve on microcontrollers that have usually much simpler memory management and segmentation, as compared to traditional desktop and server grade processing environments, and can make it difficult to prevent users from modifying/overwriting the provider's code. Aspect of this disclosure related to a mechanism for a particular class of microcontrollers which address this problem.

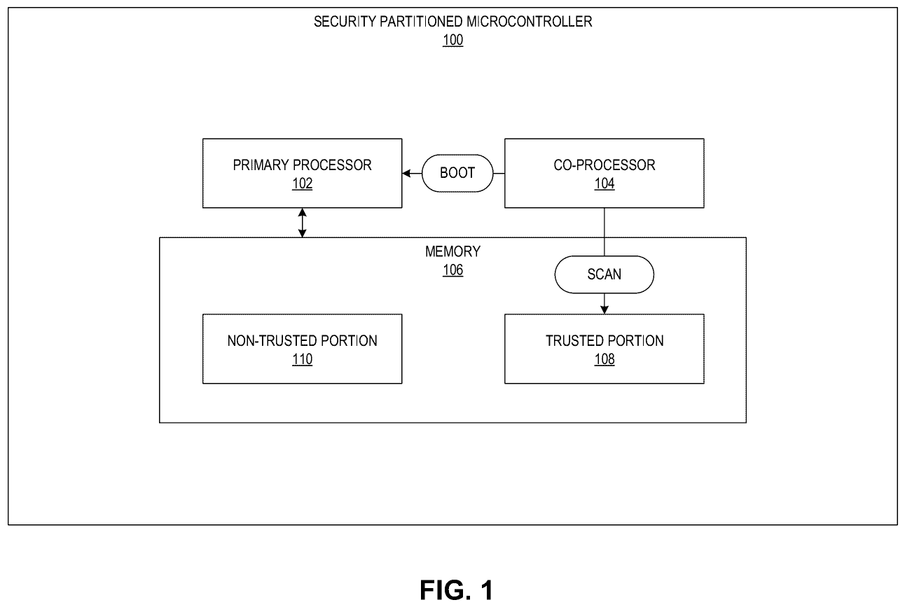

FIG. 1 is an example of a security partitioned microcontroller 100 in accordance with aspects of this disclosure. As shown in FIG. 1, the security partitioned microcontroller 100 includes a primary processor 102, a co-processor 104, and a memory 106. The memory 106 includes a trusted portion 108 and a non-trusted portion 110. The memory 106 has stored thereon a first set of instructions in the trusted portion 108 and a second set of instructions in the non-trusted portion 110. The co-processor 104 is configured to in response to booting the security partitioned microcontroller 100, scan the trusted portion 108 of the memory 106 for the first set of instructions. The co-processor 104 is further configured to allow the primary processor 102 to boot in response to determining that the first set of instructions is present in the trusted portion 108 of the memory 106.

In one scenario, a user is provided a security partitioned microcontroller device (e.g., the security partitioned microcontroller 100 of FIG. 1) configured to provide usage data/metrics to a provider of the device. For example, the user can be provided with a “rented” device after entering into agreement to provide usage data for peripheral/API access, which may be billed to the user. According to aspects of this disclosure, the device can be setup with an environment to enable this scenario. In some embodiments, this environment can include one or more of the following features, which are numbered below.
1. Providing a user with a microcontroller (e.g., the security partitioned microcontroller 100) including a primary processor (e.g., the primary processor 102 of FIG. 1) with an attached co-processor (e.g., the co-processor 104 of FIG. 1) such as Tiny Enclave. The primary processor's memory map is configured to prevent access to at least some of the peripherals from the user controlled non-secure non-trusted environment, such that usage of the peripherals can be monitored from the trusted side.
2. Providing a user with a minimal image pre-flashed on the trusted secure environment. This the pre-flashed image can include:
a) Driver code (and a corresponding API) for various peripherals that are configured to be monitored (e.g., for billing purposes) that includes instrumentation and a relatively small internet protocol (IP) stack with transport layer security (TLS) for communicating with the provider's servers about usage metrics.
b) Functionality that can be called from the non-trusted environment to instruct the co-processor to run updates/swap images for the trusted domain.
c) In some embodiments, the trusted environment can include a memory-protection unit (MPU) configured to run all of the provider's code in a higher-privileged operating mode. The provider's code can use the MPU as a “cage” on the trusted domain.
3. Providing the user with a custom toolchain configured to:
a) Allow the user to build a non-instrumented binary that has full access to the non-trusted domain.
b) Allow the user to build an instrumented self-contained binary to be loaded on to the trusted domain at a later time.
c) Place all or substantially all calls to “metered” peripherals in the trusted binary along with hook code configured to hook the calls into the driver code provided in the pre-flashed image on the trusted side. The custom toolchain can remove calls that require privilege and may lead to re-writing of the trusted pre-flashed image. This may lead to build issues which can be resolved by the user by rewriting the user code to remove calls that require privilege. Only privileged code allowed will be interrupt handlers that are strictly for peripheral access and control via the provider's provided APIs. All other customer code and algorithms will be left untouched.
d) Sign trusted binary with user-provisioned keys from the provider. The same keys can be made available for verification in the security co-processor.

In some embodiments, a process for using a security partitioned device includes one or more of the following features, which are numbered below.
1. The user loads the untrusted firmware using the custom toolchain onto the security partitioned device. The user is able to store their trusted firmware binary on any available memory but is not able to reflash the pre-flashed image on the trusted memory. If the pre-flashed image is reflashed, on boot the security processor will scan for the pre-flashed image, and if not found, will cause the device to reset. The security co-processor can also be augmented with its own communication stack to signal to the provider that the user has cleaned and/or threatened the device. In response to receiving such a signal, the user can be warned that reflashing the pre-flashed image on the trusted memory will prevent the device from booting (e.g., because reflashing the pre-flashed image violates the terms of service) and asked to reflash the provider's original image from a secure link. In some implementations, if violations continue to occur, the user can be billed for the device plus a penalty for loss of revenue since they violated the peripheral/API access clause. The user can also have pre-communicated with the provider their intentions to reflash the pre-flashed image, to close out any contracts, and take full control of the device without penalty.
2. The user can call secure functionality during untrusted code runtime, to load the secure binary into the trusted memory.
3. The secure co-processor reads the binary, verifies the signature of the binary, ensures hook code is present, determines that an expected version of the pre-flashed image matches the version of the generated hooks (to ensure hooks work correctly), and performs other sanity checks.
4. The secure co-processor then loads the binary and begins the binary's initialization code in lower-privileged context on the trusted side. The user's binary is successfully loaded. In some embodiments, rather than loading the user's binary after verifying the signature of the binary, the user's binary can be flashed to the trusted memory (e.g., alongside the provider's original image) by the custom toolchain. The co-processor can verify the pre-flashed version of the user's binary during bootup.
5. Since the user's code will always be unprivileged, and sufficient functionality is provided that they can still run privileged code (e.g., using the provider's APIs), the user is able to utilize both the trusted and untrusted domains of the microcontroller with the provider providing minimal invasive code for non-metered peripherals and device operations. Calls to metered peripherals that must be made directly from the non-secure domain can also be routed through the provider's API that hooks into the secure pre-flashed image drivers.

Typically, trusted code is used as a mechanism to provide oversight into the non-trusted execution. Further, mixing a secure co-processor with a security partitioned (e.g., using TrustZone) microcontroller is usually to offload secure computations, as well as to perform commonly understood operations such as secure boot. Aspects of this disclosure enable the device to use the security co-processor as a verification mechanism to load user provided binaries, which can interact with pre-existing code in the trusted domain such that the code is able to meter device peripheral access.

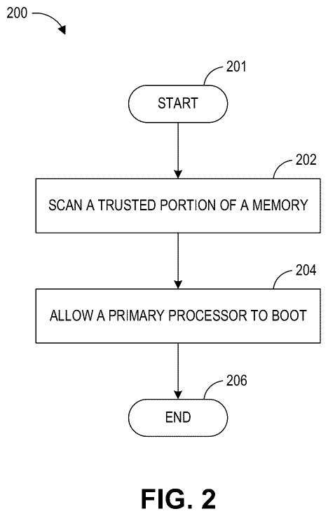

FIG. 2 is an example method 200 of using a security partitioned microcontroller in accordance with aspects of this disclosure. In some embodiments, the method can be performed by the security partitioned microcontroller 100 of FIG. 1, with certain portions of the method being performed by the primary processor 102, the co-processor 104, and/or the memory 106.

At block 202, the method 200 involves scanning, using a co-processor, a trusted portion of a memory of the security partitioned microcontroller for a first set of instructions in response to booting the security partitioned microcontroller. At block 204, the method 200 involves allowing, using the co-processor, a primary processor of the security partitioned microcontroller to boot in response to determining that the first set of instructions is present in the trusted portion of the memory.

In some embodiments, the method 200 further involves creating, using the primary processor, a trusted execution environment and execute the first set of instructions within the trusted execution environment, and creating, using the primary processor, a non-trusted execution environment and execute a second set of instructions within the non-trusted execution environment, the second set of instructions being stored in a non-trusted portion of the memory.

In some embodiments, the first set of instructions are pre-flashed into the trusted portion of the memory. The microcontroller can include one or more peripherals, and the first set of instructions can include driver code and an application programming interface (API) for accessing the one or more peripherals. In some embodiments, the peripherals can include: a DSP configured to run specialized algorithms (e.g., proprietary algorithms) and/or an ML accelerator configured to run specialized ML models (e.g., proprietary ML models).

In some embodiments, the method 200 further involves preventing access, using a hardware-based access controller of the microcontroller that segments the memory into the trusted portion and the non-trusted portion, to the one or more peripherals from the non-trusted execution environment.

In some embodiments, the method 200 further involves monitoring, using the driver code executed by the primary processor, usage of the one or more peripherals, generating usage metrics representing the usage of the one or more peripherals, and communicating the usage metrics to a provider of the microcontroller. The first set of instructions can include a first sub-set of instructions provided by a provider of the microcontroller and a second sub-set of instructions provided by a user. When accessing the one or more peripherals, the user can send data from the partitioned microcontroller to the DSP and/or ML accelerator for processing and tracking of the usage of these peripherals.

In some embodiments, the method 200 further involves calling, using the primary processor executing the second set of instructions, functionality from the non-trusted execution environment to instruct the co-processor to load a third set of instructions into the trusted execution environment of the primary processor.

In some embodiments, the method 200 further involves receiving, by the co-processor, a request to load a user provided third set of instructions into the trusted execution environment, reading the third set of instructions, verifying a signature of the third set of instructions, determining that a hook code is present in the third set of instructions, determining an expected version of the third set of instructions matches a version of the hook code, and loading, by the co-processor, the third set of instructions in a lower-privileged context in the trusted execution environment of the primary processor in response to verifying the signature and determining that the expected version matches the version of the hook code.

In some embodiments, the method 200 further involves running, using a memory-protection unit (MPU) of the trusted execution environment, the first set of instructions in a higher-privileged operating mode.

In the foregoing, it will be appreciated that any feature of any one of the embodiments can be combined or substituted with any other feature of any other one of the embodiments.

Aspects of this disclosure can be implemented in various electronic devices. Examples of the electronic devices can include, but are not limited to, consumer electronic products, parts of the consumer electronic products, electronic test equipment, automotive equipment, cellular communications infrastructure such as a base station, etc.

Unless the context clearly requires otherwise, throughout the description and the claims, the words “comprise,” “comprising,” “include,” “including” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number, respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or whether these features, elements and/or states are included or are to be performed in any particular embodiment.

While certain embodiments have been described, these embodiments have been presented by way of example only, and are not intended to limit the scope of the disclosure. Indeed, the novel apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. Each of these blocks may be implemented in a variety of different ways. Any suitable combination of the elements and acts of the various embodiments described above can be combined to provide further embodiments. The various features and processes described above may be implemented independently of one another, or may be combined in various ways. All possible combinations and sub-combinations of features of this disclosure are intended to fall within the scope of this disclosure.

What is claimed is:

1. A security partitioned microcontroller, comprising:
a primary processor;
a memory coupled to the primary processor, wherein the memory is segmented into a trusted portion and a non-trusted portion, the memory having stored thereon a first set of instructions in the trusted portion and a second set of instructions in the non-trusted portion; and
a co-processor configured to:
in response to booting the security partitioned microcontroller, scan the trusted portion of the memory for the first set of instructions, and
allow the primary processor to boot in response to determining that the first set of instructions is present in the trusted portion of the memory.

2. The microcontroller of claim 1, wherein the first set of instructions and the second set of instructions, when executed by the primary processor, cause the primary processor to:
create a trusted execution environment and execute the first set of instructions within the trusted execution environment, and
create a non-trusted execution environment and execute the second set of instructions within the non-trusted execution environment.

3. The microcontroller of claim 2, wherein the first set of instructions are pre-flashed into the trusted portion of the memory.

4. The microcontroller of claim 3, further comprising:
one or more peripherals,
wherein the first set of instructions comprise driver code and an application programming interface (API) for accessing the one or more peripherals.

5. The microcontroller of claim 4, further comprising a hardware-based access controller that segments the memory into the trusted portion and the non-trusted portion wherein the hardware-based access controller is configured to prevent access to the one or more peripherals from the non-trusted execution environment.

6. The microcontroller of claim 4, wherein the driver code, when executed by the primary processor, causes the primary processor to monitor usage of the one or more peripherals, generate usage metrics representing the usage of the one or more peripherals, and communicate the usage metrics to a provider of the microcontroller.

7. The microcontroller of claim 2, wherein the first set of instructions comprise a first sub-set of instructions provided by a provider of the microcontroller and a second sub-set of instructions provided by a user.

8. The microcontroller of claim 2, wherein the second set of instructions, when executed by the primary processor, cause the primary processor to:
call functionality from the non-trusted execution environment to instruct the co-processor to load a third set of instructions into the trusted execution environment of the primary processor.

9. The microcontroller of claim 2, wherein the co-processor is further configured to:
receive a request to load a user provided third set of instructions into the trusted execution environment,
read the third set of instructions,
verify a signature of the third set of instructions,
determine that a hook code is present in the third set of instructions,
determines an expected version of the third set of instructions matches a version of the hook code, and
load the third set of instructions in a lower-privileged context in the trusted execution environment of the primary processor in response to verifying the signature and determining that the expected version matches the version of the hook code.

10. The microcontroller of claim 2, wherein the trusted execution environment comprises:
a memory-protection unit (MPU) configured to run the first set of instructions in a higher-privileged operating mode.

11. A method of using a security partitioned microcontroller, comprising:
scanning, using a co-processor, a trusted portion of a memory of the security partitioned microcontroller for a first set of instructions in response to booting the security partitioned microcontroller; and
allowing, using the co-processor, a primary processor of the security partitioned microcontroller to boot in response to determining that the first set of instructions is present in the trusted portion of the memory.

12. The method of claim 11, further comprising:
creating, using the primary processor, a trusted execution environment and execute the first set of instructions within the trusted execution environment; and
creating, using the primary processor, a non-trusted execution environment and execute a second set of instructions within the non-trusted execution environment, the second set of instructions being stored in a non-trusted portion of the memory.

13. The method of claim 11, wherein the first set of instructions are pre-flashed into the trusted portion of the memory.

14. The method of claim 13, wherein:
the microcontroller comprises one or more peripherals, and
the first set of instructions comprise driver code and an application programming interface (API) for accessing the one or more peripherals.

15. The method of claim 14, further comprising:
preventing access, using a hardware-based access controller of the microcontroller that segments the memory into the trusted portion and the non-trusted portion, to the one or more peripherals from the non-trusted execution environment.

16. The method of claim 14, further comprising:
monitoring, using the driver code executed by the primary processor, usage of the one or more peripherals;
generating usage metrics representing the usage of the one or more peripherals, and
communicating the usage metrics to a provider of the microcontroller.

17. A non-transitory computer-readable memory having stored thereon instructions that, when executed by a microcontroller, cause the microcontroller to:
scan, using a co-processor of the microcontroller, a trusted portion of a memory of the microcontroller for a first set of instructions in response to booting the microcontroller; and
allow, using the co-processor, a primary processor of the microcontroller to boot in response to determining that the first set of instructions is present in the trusted portion of the memory.

18. The non-transitory computer readable memory of claim 17, wherein the instructions, when executed by the microcontroller, cause the microcontroller to:
create, using the primary processor, a trusted execution environment and execute the first set of instructions within the trusted execution environment; and
create, using the primary processor, a non-trusted execution environment and execute a second set of instructions within the non-trusted execution environment, the second set of instructions being stored in the non-trusted portion of the memory.

19. The non-transitory computer readable memory of claim 17, wherein the first set of instructions are pre-flashed into the trusted portion of the memory.

20. The non-transitory computer readable memory of claim 19, wherein:
the microcontroller comprises one or more peripherals, and
the first set of instructions comprise driver code and an application programming interface (API) for accessing the one or more peripherals.
